(19) United States
(12) Patent Application Publication
(10) Pub. No.: US 2024/0348329 A1
(43) Pub. Date: Oct. 17, 2024

(54) METHOD AND DEVICE FOR SETTING COMMUNICATION-PATH IN CLUSTERED LOW EARTH ORBIT SATELLITE NETWORK, AND STORAGE MEDIUM STORING INSTRUCTIONS TO PERFORM METHOD FOR SETTING COMMUNICATION-PATH

(71) Applicant: AGENCY FOR DEFENSE DEVELOPMENT, Daejeon (KR)

(72) Inventors: Myounghun HAN, Daejeon (KR); Bongsoo ROH, Daejeon (KR); Dongwon KUM, Daejeon (KR); Kyungwoo KIM, Daejeon (KR); Kilsoo JEONG, Daejeon (KR)

(21) Appl. No.: 18/632,882

(22) Filed: Apr. 11, 2024

(30) Foreign Application Priority Data
Apr. 11, 2023 (KR) 10-2023-0047202

(51) Int. Cl. H04B 7/185; H04L 45/00; H04W 40/28

(52) U.S. Cl. CPC H04B 7/18584; H04B 7/18534; H04L 45/22; H04W 40/28; H04B 7/18576

(57) ABSTRACT

Proposed is a method for setting a communication path in a clustered low earth orbit satellite network including a plurality of low earth orbit satellites. The method may include generating topology information of each low earth orbit satellite based on orbit information of the clustered low earth orbit satellite network. The method may also include estimating a communication path between the plurality of low earth orbit satellites from the topology information using pre-trained communication-path estimation model. The method may further include setting a final communication path of the clustered low earth orbit satellite network by determining validity of the estimated communication path.

### CROSS-REFERENCE TO RELATED APPLICATION

This application claims priority to Korean Patent Application No. 10-2023-0047202 filed on Apr. 11, 2023. The entire contents of the application on which the priority is based are incorporated herein by reference.

### TECHNICAL FIELD

The present disclosure relates to a method and device for setting an optimal communication path, which can prevent the performance of a clustered low earth orbit satellite network including a plurality of low earth orbit satellites from deteriorating.

### BACKGROUND

Compared to a middle earth orbit satellite or a high earth orbit satellite, a low earth orbit satellite has advantages in terms of low delay, wide-area coverage, and miniaturization, and is leading the paradigm of next-generation communication services combined with mobile communication networks because there are no space restrictions.

### SUMMARY

One aspect is a method and device for setting an optimal communication path, which can prevent the performance of a clustered low earth orbit satellite network including a plurality of low earth orbit satellites from deteriorating.

Another aspect is a method for setting a communication path in a clustered low earth orbit satellite network including a plurality of low earth orbit satellites, the method comprises generating topology information of each low earth orbit satellite based on orbit information of the clustered low earth orbit satellite network; estimating a communication path between the plurality of low earth orbit satellites from the topology information using pre-trained communication-path estimation model; and setting a final communication path of the clustered low earth orbit satellite network by determining validity of the estimated communication path.

The setting the final communication path may include setting the estimated communication path as the final communication path, when all communication links between the low earth orbit satellites included in the estimated communication path is valid; and setting an alternative communication path to change the estimated communication path and setting the changed communication path as the final communication path, when at least one communication link among the plurality of communication links is invalid.

The setting the final communication path may further include changing the estimated communication path to the alternative communication path, when the alternative communication path may be set within a preset time range; and waiting for generation of subsequent topology information, when the alternative communication path may not be set within the preset time range.

Herein, the validity of the estimated communication path may be determined depending on whether there is a response message between the low earth orbit satellites included in the estimated communication path.

The generating topology information may include estimating a location of each low earth orbit satellite on the basis of the orbit information; mapping a plurality of satellite nodes corresponding to the plurality of low earth orbit satellites, respectively, and a communication link between the plurality of satellite nodes to a virtual topology based on the estimated location of each low earth orbit satellite; setting a color satellite node and a color and width of the communication link based on a preset color table; and generating the topology information by adjusting color transparency of the communication link based on network state information for each time zone.

Herein, each satellite node may include a plurality of division areas corresponding to a transmission link and a reception link for a plurality of communication directions of each low earth orbit satellite, and each division area may be set to a different color based on the network state information.

The pre-trained communication-path estimation model may be configured for reinforcement training to output the estimated communication path for the plurality of low earth orbit satellites of the clustered low earth orbit satellite network corresponding to input of the topology information and the network state information.

Another aspect is a communication path setting device in a clustered low earth orbit satellite network including a plurality of low earth orbit satellites, the communication path setting device comprises: a memory configured to store one or more instructions; and a processor configured to execute the one or more instructions stored in the memory, wherein the instructions, when executed by the processor, cause the processor to: generate topology information of each low earth orbit satellite based on orbit information of the clustered low earth orbit satellite network; estimate a communication path between the plurality of low earth orbit satellites from the topology information using pre-trained communication-path estimation model; and set a final communication path of the clustered low earth orbit satellite network by determining validity of the estimated communication path.

The processor may be configured to set the estimated communication path as the final communication path, when all communication links between the low earth orbit satellites included in the estimated communication path is valid; and set an alternative communication path to change the estimated communication path and set the changed communication path as the final communication path, when at least one communication link among the plurality of communication links is invalid.

The processor may be configured to change the estimated communication path to the alternative communication path, when the alternative communication path may be set within a preset time range; and wait for generation of subsequent topology information, when the alternative communication path may not be set within the preset time range.

The processor may be configured to determine a disrupted communication link among the plurality of communication links; set the alternative communication path by extracting at least one alternative link from remaining communication links excluding the disrupted communication link; and change the estimated communication path using the alternative communication path.

The processor may be configured to determine the validity of the estimated communication path depending on whether there is a response message between the low earth orbit satellites included in the estimated communication path.

The processor may be configured to estimate a location of each low earth orbit satellite on the basis of the orbit information; map a plurality of satellite nodes corresponding to the plurality of low earth orbit satellites, respectively, and a communication link between the plurality of satellite nodes to a virtual topology based on the estimated location of each low earth orbit satellite; set a color satellite node and a color and width of the communication link based on a preset color table; and generate the topology information by adjusting color transparency of the communication link based on network state information for each time zone.

Each satellite node may include a plurality of division areas corresponding to a transmission link for a plurality of communication directions of each low earth orbit satellite and a reception link for the plurality of communication directions of each low earth orbit satellite, and each division area is set to a different color based on the network state information.

The pre-trained communication-path estimation model may be configured for reinforcement training to output the estimated communication path for the plurality of low earth orbit satellites of the clustered low earth orbit satellite network corresponding to input of the topology information and the network state information.

Another aspect is a non-transitory computer readable storage medium storing computer executable instructions, wherein the instructions, when executed by a processor, cause the processor to perform a method for setting a communication path in a clustered low earth orbit satellite network including a plurality of low earth orbit satellites, the method comprising: generating topology information of each low earth orbit satellite based on orbit information of the clustered low earth orbit satellite network; estimating a communication path between the plurality of low earth orbit satellites from the topology information using pre-trained communication-path estimation model; and setting a final communication path of the clustered low earth orbit satellite network by determining validity of the estimated communication path.

The present disclosure can estimate a communication path for a plurality of low earth orbit satellites of a clustered low earth orbit satellite network 100 from topology information for each time zone using a previously learned neural network model, and can set a final communication path according to the determination of the validity of the estimated communication path.

Therefore, the present disclosure can establish a fast and accurate communication path between the plurality of low earth orbit satellites even without searching for a separate communication path. This prevents the loss of transmitted/received data packet, thus preventing the performance of the clustered low earth orbit satellite network 100 from deteriorating.

### BRIEF DESCRIPTION OF THE DRAWINGS

FIG. 1 is a diagram showing a clustered low earth orbit satellite network according to an embodiment of the present disclosure.

FIG. 2 is a diagram showing a communication-path setting device of a clustered low earth orbit satellite network according to an embodiment of the present disclosure.

FIG. 3 is a diagram conceptually showing the function of a path-setting program of FIG. 2.

FIG. 4 is a diagram showing a method of training a communication-path estimation part of FIG. 3.

FIG. 5 is a flowchart showing a communication-path setting method of a clustered low earth orbit satellite network according to an embodiment of the present disclosure.

FIG. 6 is a flowchart specifically showing a method of generating topology information of FIG. 5.

FIG. 7 is a diagram showing an embodiment for topology information of the present disclosure.

FIG. 8 is a flowchart specifically showing a method of changing a communication path of FIG. 5.

FIG. 9 is a diagram showing an embodiment for a method of changing a communication path of the present disclosure.

### DETAILED DESCRIPTION

A clustered low earth orbit satellite network including dozens or hundreds of low earth orbit satellites is advantageous in that a propagation delay time is shorter and a required communication signal output is lower compared to a geostationary orbit satellite network, enabling personal mobile terminal services. The clustered low earth orbit satellite network includes an inter-satellite link (ISL) for communication between the plurality of low earth orbit satellites, and a spot beam and a feeder link for communication between the low earth orbit satellite and the ground.

In the clustered low earth orbit satellite network, the inter-satellite link is formed through high-speed laser communication, and should track the constantly changing locations of the low earth orbit satellites to maintain a stable link and thus adjust the antenna direction of each low earth orbit satellite.

In the clustered low earth orbit satellite network, the above-described inter-satellite link may be disrupted in a seam area where the orbit directions of the plurality of low earth orbit satellites intersect or in a pole area where the orbits intersect. The link disruption causes a change in topology, which results in deterioration of network performance.

Therefore, conventionally, a routing protocol applied to a terrestrial Internet environment is used to prevent the link disruption and the change in topology. However, the existing routing protocol is problematic in that it has a delay in responding to link disruption and topology change that occur regularly and periodically in the clustered low earth orbit satellite network, so the performance of the network may deteriorate.

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

Hereinafter, a preferred embodiment of the present disclosure will be described in detail with reference to the accompanying drawings.

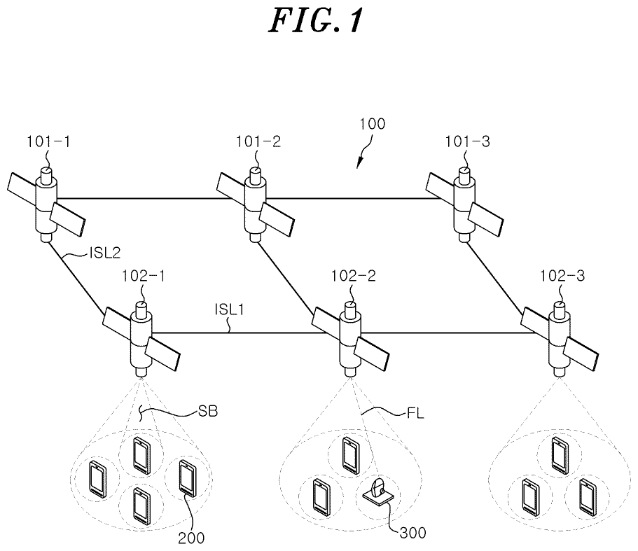

FIG. 1 is a diagram showing a clustered low earth orbit satellite network according to an embodiment of the present disclosure.

Referring to FIG. 1, a clustered low earth orbit satellite network 100 of this embodiment may include a plurality of low earth orbit satellites 101 and 102 that are disposed at a predetermined altitude above the ground and move in a preset direction. Each of the plurality of low earth orbit satellites 101 and 102 may be configured such that a predetermined number of low earth orbit satellites are clustered into a group, and the low earth orbit satellites of each group may be disposed in different orbits.

For example, the plurality of low earth orbit satellites 101 and 102 may be clustered into a first satellite group and a second satellite group. The first satellite group may include a 1-1 low earth orbit satellite 101-1, a 1-2 low earth orbit satellite 101-2, and a 1-3 low earth orbit satellite 101-3 disposed on a first orbit. Further, the second satellite group may include a 2-1 low earth orbit satellite 102-1, a 2-2 low earth orbit satellite 102-2, and a 2-3 low earth orbit satellite 102-3 disposed on a second orbit different from the first orbit.

Each of the plurality of low earth orbit satellites 101 and 102 may form a communication path with an adjacent satellite or a ground terminal device according to a set communication path. Thus, the plurality of low earth orbit satellites 101 and 102 may transmit a data packet by performing data communication from a transmitting node to a receiving node through the set communication path. Here, the transmitting node and the receiving node may be one low earth orbit satellite or a ground terminal.

For example, the 1-1 low earth orbit satellite 101-1 of the first satellite group may form a first communication link, e.g. a first inter-satellite link ISL1, with the adjacent 1-2 low earth orbit satellite 101-2 in the orbit, i.e. the first orbit. Further, the 1-2 low earth orbit satellite 101-2 may form a second communication link, e.g. a second inter-satellite link ISL2, with the adjacent 2-2 low earth orbit satellite 102-2 in a different orbit, i.e. the second orbit. As such, the communication path including the first communication link and the second communication link may be established between the 1-1 low earth orbit satellite 101-1 and the 2-2 low earth orbit satellite 102-2 among the plurality of low earth orbit satellites 101 and 102.

Thus, when the data packet is transmitted from the transmitting node, e.g. a user terminal 200 on the ground to the 1-1 low earth orbit satellite 101-1, the 1-1 low earth orbit satellite 101-1 transmits the data packet along a preset communication path, that is, the first communication link and the second communication link, to the 2-2 low earth orbit satellite 102-2, and the 2-2 low earth orbit satellite 102-2 transmits the received data packet to the receiving node, e.g. a satellite base station 300, on the ground, thereby enabling data communication between the transmitting node and the receiving node.

Here, communication may be performed between the transmitting node and the 1-1 low earth orbit satellite 101-1 through a spot beam SB, and communication may be performed between the receiving node and the 2-2 low earth orbit satellite 102-2 through a feeder link FL.

As such, the clustered low earth orbit satellite network 100 of this embodiment may perform data communication between the transmitting node and the receiving node through the communication path established in the plurality of low earth orbit satellites 101 and 102.

Here, the clustered low earth orbit satellite network 100 needs to set an optimal communication path to the plurality of low earth orbit satellites 101 and 102 so as to prevent the loss of the data packet transmitted from the transmitting node to the receiving node.

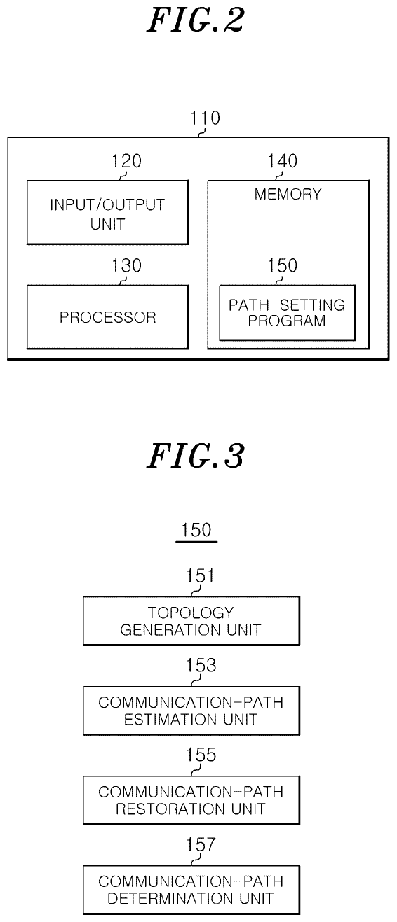

To this end, the present disclosure may have a communication-path setting device 110 (see FIG. 2) including a previously learned neural network model to estimate the communication path on each of the plurality of low earth orbit satellites 101 and 102, and may establish the optimal communication path of the clustered low earth orbit satellite network 100 using the communication-path setting device.

FIG. 2 is a diagram showing a communication-path setting device of a clustered low earth orbit satellite network according to an embodiment of the present disclosure.

The communication-path setting device 110 shown in FIG. 2 may be included in each of the plurality of low earth orbit satellites 101 and 102 of the clustered low earth orbit satellite network 100. However, for the convenience of explanation, the communication-path setting device 110 included in the 1-1 low earth orbit satellite 101-1 among the plurality of low earth orbit satellites 101 and 102 will be described, and the remaining low earth orbit satellites may also include substantially the same configuration as the communication-path setting device 110 of the 1-1 low earth orbit satellite 101-1.

Referring to FIGS. 1 and 2, the communication-path setting device 110 of this embodiment may establish the communication path between the 1-1 low earth orbit satellite 101-1 and one or more adjacent low earth orbit satellites using the previously learned neural network model, e.g. the neural network model for setting the communication path. Such a communication-path setting device 110 may include an input/output part 120, a processor 130, and a memory 140.

The input/output part 120 may receive information about the clustered low earth orbit satellite network 100, e.g. orbit information and network state information, from an external device, such as the satellite base station 300 for managing the low earth orbit satellite on the ground.

Here, the network state information may include information about a communication state between the plurality of low earth orbit satellites of the clustered low earth orbit satellite network 100, for instance, communication-signal intensity information, bandwidth information, delay information, QoS information, etc.

Further, the input/output part 120 may receive the data packet provided from the transmitting node or the adjacent low earth orbit satellite on the basis of the communication path established by the processor 130, for instance, a transmission/reception communication link of the 1-1 low earth orbit satellite 101-1, and may transmit the data packet through the established communication path to another adjacent low earth orbit satellite or the receiving node.

The processor 130 may receive the orbit information and the network state information through the input/output part 120, and may set a communication path for the 1-1 low earth orbit satellite 101-1 using a path-setting program 150 stored in the memory 140.

The memory 140 may store the path-setting program 150 and information required for executing the path-setting program. The path-setting program 150 may be software including commands that may generate topology information on the basis of the orbit information and the network state information and may set the communication path of the 1-1 low earth orbit satellite 101-1 using the topology information.

Thus, the processor 130 may execute the path-setting program 150 stored in the memory 140, generate the topology information on the basis of the orbit information using the path-setting program, and generate the communication path including the communication link for transmitting/receiving the data of the 1-1 low earth orbit satellite 101-1 on the basis of the topology information and the network state information.

FIG. 3 is a diagram conceptually showing the function of the path-setting program of FIG. 2.

Referring to FIG. 3, the path-setting program 150 of this embodiment may include a topology generation part 151, a communication-path estimation part 153, a communication-path restoration part 155, and a communication-path determination part 157.

The topology generation part 151, communication-path estimation part 153, communication-path restoration part 155, and communication-path determination part 157 shown in FIG. 3 are conceptually divided to easily explain the function of the path-setting program 150 in this embodiment, and the present disclosure is not limited thereto.

For example, the functions of the topology generation part 151, the communication-path estimation part 153, the communication-path restoration part 155, and the communication-path determination part 157 may be merged or separated, and may be implemented as a series of commands included in one program.

The topology generation part 151 may generate topology information on the basis of the orbit information of the clustered low earth orbit satellite network 100 that is provided through the input/output part 120.

Here, the topology information may include a plurality of satellite nodes for the plurality of low earth orbit satellites mapped to a virtual topology on the basis of a location of each of the plurality of low earth orbit satellites of the clustered low earth orbit satellite network 100 estimated on the basis of the orbit information and a plurality of communication links connecting the plurality of satellite nodes.

Further, the topology generation part 151 may set a color of each of the plurality of satellite nodes of the topology information on the basis of the network state information. Further, the topology generation part 151 may set the color and width of each of the plurality of communication links connecting the plurality of satellite nodes on the basis of the network state information.

Here, the topology generation part 151 may set a color for each of the plurality of satellite nodes and the plurality of communication links on the basis of a preset color table, for instance, an RGBA (red, green, blue, alpha) color table. At this time, the width of each of the plurality of communication links may vary depending on the signal intensity according to the network state information.

Further, the topology generation part 151 may adjust the transparency of each of a plurality of preset communication links on the basis of the network state information for each time zone. At this time, the transparency of each of the plurality of communication links may vary depending on a change in signal intensity for each time zone.

The communication-path estimation part 153 may estimate the communication path of the 1-1 low earth orbit satellite 101-1 on the basis of the topology information generated by the topology generation part 151 and the network state information corresponding to the topology information.

Here, the communication path may include a transmission/reception link for an adjacent node of the 1-1 low earth orbit satellite 101-1, such as an adjacent low earth orbit satellite, for instance, a transmission link and a reception link for the data packet.

Such a communication-path estimation part 153 may include a neural network model learned to estimate the communication path of the 1-1 low earth orbit satellite 101-1.

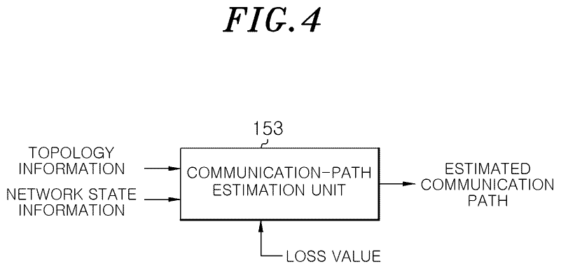

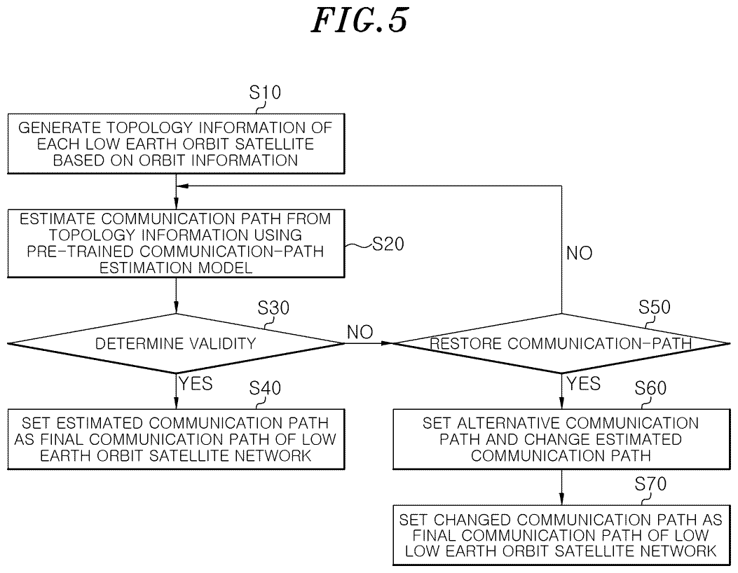

FIG. 4 is a diagram showing a method of training a communication-path estimation part of FIG. 3.

Referring to FIG. 4, when the communication-path estimation part 153 of this embodiment receives topology information for each time zone and network state information corresponding thereto, it may be trained to output an estimated communication path for the 1-1 low earth orbit satellite 101-1.

To learn the communication path estimation, the communication-path estimation part 153 of this embodiment may receive topology information generated on the basis of orbit information for each of a plurality of past times and network state information corresponding thereto as learning data.

Further, the communication-path estimation part 153 may further receive a loss value due to the data packet loss or delay according to the estimated communication path, and may repeatedly perform learning on the communication path estimation of the 1-1 low earth orbit satellite 101-1 so that the loss value is minimized. At this time, the communication-path estimation part 153 may perform deep reinforcement learning to estimate the communication path for the 1-1 low earth orbit satellite 101-1.

Thus, the communication-path estimation part 153, which has completed learning, may estimate and output the communication path for the 1-1 low earth orbit satellite 101-1 on the basis of the topology information generated based on the orbit information provided through the input/output part 120 and the network state information at the time the topology information is generated.

Turning back to FIG. 3, the communication-path restoration part 155 may determine the validity of the communication path estimated by the communication-path estimation part 153, and may set an alternative communication path according to the result to restore the estimated communication path.

For example, the 1-1 low earth orbit satellite 101-1 may form a communication link with the 1-2 low earth orbit satellite 101-2, which is another adjacent low earth orbit satellite, along the estimated communication path output from the communication-path estimation part 153.

Thus, the communication-path restoration part 155 may determine whether the 1-2 low earth orbit satellite 101-2 transmits a response message to the data packet transmitted from the 1-1 low earth orbit satellite 101-1 according to the estimated communication path, and may determine the validity of the estimated communication path.

At this time, unless the response message is transmitted from the 1-2 low earth orbit satellite 101-2, the communication-path restoration part 155 may determine that the estimated communication path is invalid, and may set another communication path, that is, an alternative communication path.

Further, when the estimated communication path is invalid, the communication-path restoration part 155 may determine whether to set the alternative communication path during a preset time range, for example, a time during which the communication path for the corresponding topology is maintained according to topology information for each time zone.

At this time, if it is possible to set the alternative communication path within a set time range, the communication-path restoration part 155 may set the alternative communication path within the corresponding time. Further, if it is impossible to set the alternative communication path within the set time range, the communication-path restoration part 155 may not set the alternative communication path. At this time, the 1-1 low earth orbit satellite 101-1 may postpone data packet transmission to the 1-2 low earth orbit satellite 101-2, and the communication-path estimation part 153 may wait for the reception of topology information generated at a subsequent time, that is, a next time zone.

The communication-path determination part 157 may set a final communication path of the clustered low earth orbit satellite network 100 on the basis of the validity determination result of the communication-path restoration part 155 and the alternative communication path set according to the result.

For example, when the communication-path restoration part 155 determines that the estimated communication path is valid, the communication-path determination part 157 may set the estimated communication path as a final communication path, that is, a final communication path between the 1-1 low earth orbit satellite 101-1 and the 1-2 low earth orbit satellite 101-2 in a corresponding time zone.

Further, when the communication-path restoration part 155 determines that the estimated communication path is invalid, the communication-path determination part 157 may change the established communication path using the alternative communication path set in the communication-path restoration part 155, and may set the changed communication path as the final communication path between the 1-1 low earth orbit satellite 101-1 and the 1-2 low earth orbit satellite 101-2 in a corresponding time zone.

As such, the communication-path setting device 110 of this embodiment may estimate the communication path for each time zone for the plurality of low earth orbit satellites of the clustered low earth orbit satellite network 100 from the topology information for each time zone using a previously learned neural network model.

Further, the communication-path setting device 110 of this embodiment may estimate the communication path for the plurality of low earth orbit satellites of the clustered low earth orbit satellite network 100 from the topology information for each time zone using the previously learned neural network model, and may set the final communication path according to the determined validity of the estimated communication path.

Thus, the present disclosure may establish a fast and accurate communication path between the plurality of low earth orbit satellites even without searching for a separate communication path. This prevents the loss of the transmitted/received data packet, thus preventing the performance of the clustered low earth orbit satellite network 100 from deteriorating.

FIG. 5 is a flowchart showing a communication-path setting method of a clustered low earth orbit satellite network according to an embodiment of the present

Hereinafter, for the convenience of explanation, as shown in FIG. 1, the clustered low earth orbit satellite network 100 includes three low earth orbit satellites of the first satellite group disposed in the first orbit and three low earth orbit satellites of the second satellite group disposed in the second orbit. The method of setting the communication path between the plurality of low earth orbit satellites will be described.

Referring to FIG. 5, the processor 130 of the communication-path setting device 110 may receive orbit information and network state information through the input/output part 120, and execute the path-setting program 150 stored in the memory 140 to set the communication path between the plurality of low earth orbit satellites of the clustered low earth orbit satellite network 100.

First, the topology generation part 151 may generate topology information of each of the plurality of low earth orbit satellites on the basis of the orbit information provided from the input/output part 120 (S10).

Here, the topology information may include a plurality of satellite nodes for the plurality of low earth orbit satellites mapped to a virtual topology on the basis of a location of each of the plurality of low earth orbit satellites of the clustered low earth orbit satellite network 100 estimated on the basis of the orbit information and a plurality of communication links connecting the plurality of satellite nodes.

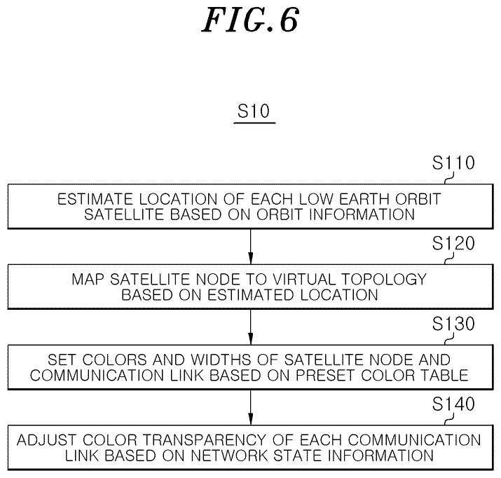

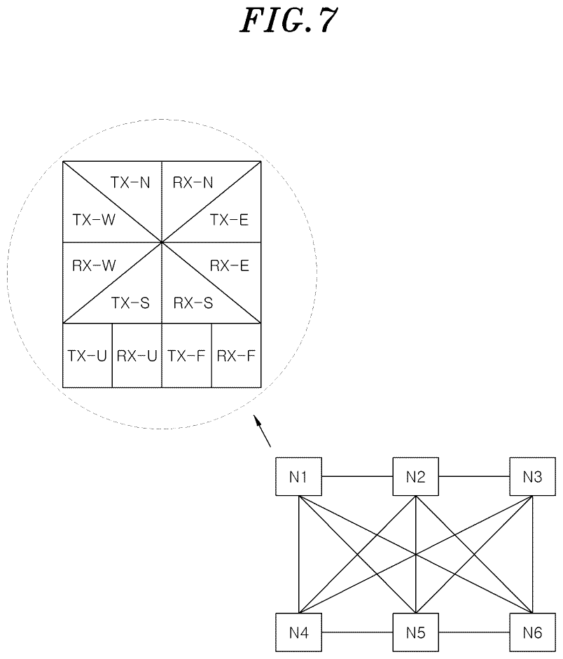

FIG. 6 is a flowchart specifically showing a method of generating topology information of FIG. 5, and FIG. 7 is a diagram showing an embodiment for topology information of the present disclosure.

Referring to FIG. 6, the topology generation part 151 may estimate a location of each of the plurality of low earth orbit satellites on the basis of the orbit information (S110).

Subsequently, the topology generation part 151 may map the plurality of satellite nodes corresponding to the plurality of low earth orbit satellites to the virtual topology on the basis of the estimated location of the low earth orbit satellite (S120).

For example, the virtual topology may include a plurality of grids. The topology generation part 151 may calculate a Euclidean distance on the basis of the estimated location coordinate of the satellite, and may map the grid corresponding to a minimum distance among the plurality of grids as the satellite node of the corresponding satellite on the basis of the calculated distance.

As shown in FIG. 7, the topology generation part 151 may map a first satellite node N1, a second satellite node N2, and a third satellite node N3 corresponding to the 1-1 low earth orbit satellite 101-1, the 1-2 low earth orbit satellite 101-2, and the 1-3 low earth orbit satellite 101-3 of the first satellite group among the plurality of low earth orbit satellites, respectively, on the basis of the orbit information.

Further, the topology generation part 151 may map a fourth satellite node N4, a fifth satellite node N5, and a sixth satellite node N6 corresponding to the 2-1 low earth orbit satellite 102-1, the 2-2 low earth orbit satellite 102-2, and the 2-3 low earth orbit satellite 102-3 of the second satellite group among the plurality of low earth orbit satellites, respectively, on the basis of the orbit information.

Here, each of the first satellite node N1 to the sixth satellite node N6 may include a plurality of division areas corresponding to communication links for a plurality of communication directions set in the corresponding low earth orbit satellite, that is, transmission/reception links.

For example, the first satellite node N1 may include eight division areas corresponding to transmission links TX-E, TX-W, TX-S, and TX-N and reception links RX-E, RX-W, RX-S, and RX-N with other adjacent low earth orbit satellites in north, south, east and west directions, and four division areas corresponding to transmission links TX-U and TX-F and reception links RX-U and RX-F with the ground user terminal 200 and the satellite base station 300.

Further, the topology generation part 151 may map a plurality of communication links connecting the first satellite node N1 to the sixth satellite node N6. For example, the topology generation part 151 may map a communication link between the first satellite node N1 and the adjacent second satellite node N2 in the same orbit, that is, the first orbit. Further, the topology generation part 151 may map a communication link between the first satellite node N1 and each of the fourth satellite node N4, the fifth satellite node N5, and the sixth satellite node N6 located in a different orbit, that is, the second orbit.

Next, the topology generation part 151 may set the colors and widths of the plurality of satellite nodes N1 to N6 and the plurality of communication links on the basis of the network state information of the clustered low earth orbit satellite network 100 provided through the input/output part 120 (S130).

Here, the topology generation part 151 may set the color of each of the plurality of satellite nodes N1 to N6 and the plurality of communication links on the basis of the preset RGBA color table.

At this time, the topology generation part 151 may set the plurality of division areas of the satellite nodes N1 to N6 to have different colors on the basis of the network state information.

Further, the topology generation part 151 enables the plurality of communication links to have different colors on the basis of the network state information. Here, the topology generation part 151 may differently set the color and width of each communication link depending on the signal intensity of the network state information.

Subsequently, the topology generation part 151 may adjust the transparency for the color of each communication link depending on a change in network state information for each time zone provided through the input/output part 120, for example, signal intensity (S140).

At this time, the topology generation part 151 may adjust the color transparency of a communication link with a relatively larger signal intensity among the plurality of communication links to be close to 0, and adjust the color transparency of a communication link with a relatively smaller signal intensity to be close to 100.

As such, the topology generation part 151 of this embodiment may generate topology information including a plurality of satellite nodes corresponding to the plurality of low earth orbit satellites and a plurality of communication links connecting the plurality of satellite nodes.

At this time, the topology generation part 151 may set the colors of the plurality of division areas and the plurality of communication links of each satellite node differently on the basis of the network state information, thereby improving learning convergence and convergence speed when the communication-path estimation part 153 performs learning using the topology information.

Turning back to FIG. 5, the communication-path estimation part 153 may be subjected to reinforcement learning on the basis of past topology information and corresponding network state information. Subsequently, the communication-path estimation part 153, which has completed learning, may receive topology information provided by the topology generation part 151 and network state information corresponding to its generation time, and then estimate the communication path between the plurality of low earth orbit satellites (S20).

Here, the estimated communication path may include the plurality of communication links for the plurality of low earth orbit satellites.

Next, the communication-path restoration part 155 may determine the validity of the communication path estimated by the communication-path estimation part 153 (S30). Here, the communication-path restoration part 155 may determine the validity of the communication path depending on whether there is a response message between the low earth orbit satellites included in the estimated communication path.

For example, when the communication path including the communication link is estimated between the first satellite node N1 corresponding to the 1-1 low earth orbit satellite 101-1 and the second satellite node N2 corresponding to the 1-2 low earth orbit satellite 101-2 on the basis of the topology information, the communication-path restoration part 155 may determine the validity for the pre-estimated communication path, depending on whether a response message is transmitted through the communication link of the 1-2 low earth orbit satellite 101-2 for the data packet transmitted from the 1-1 low earth orbit satellite 101-1.

Subsequently, when the communication-path restoration part 155 determines that the estimated communication path, that is, each of the plurality of communication links included in the estimated communication path is valid, the communication-path determination part 157 may set the estimated communication path as the final communication path of the clustered low earth orbit satellite network 100 (S40).

On the other hand, when it is determined that at least one communication link among the plurality of communication links included in the estimated communication path is invalid, the communication-path restoration part 155 may determine whether it is possible to set an alternative communication path (S50). At this time, the communication-path restoration part 155 may determine whether it is possible to set the alternative communication path within a set time range.

Next, when the alternative communication path may be set within the set time range, the communication-path restoration part 155 may set the alternative communication path, and change the pre-estimated communication path using the alternative communication path (S60).

On the other hand, when the alternative communication path may not be set within the set time range, the communication-path restoration part 155 may not set the alternative communication path. At this time, the corresponding low earth orbit satellite, that is, the low earth orbit satellite where it is determined that the communication path is invalid may postpone data packet transmission, and the communication-path estimation part 153 may wait for the reception of topology information generated from the topology generation part 151 at a subsequent time.

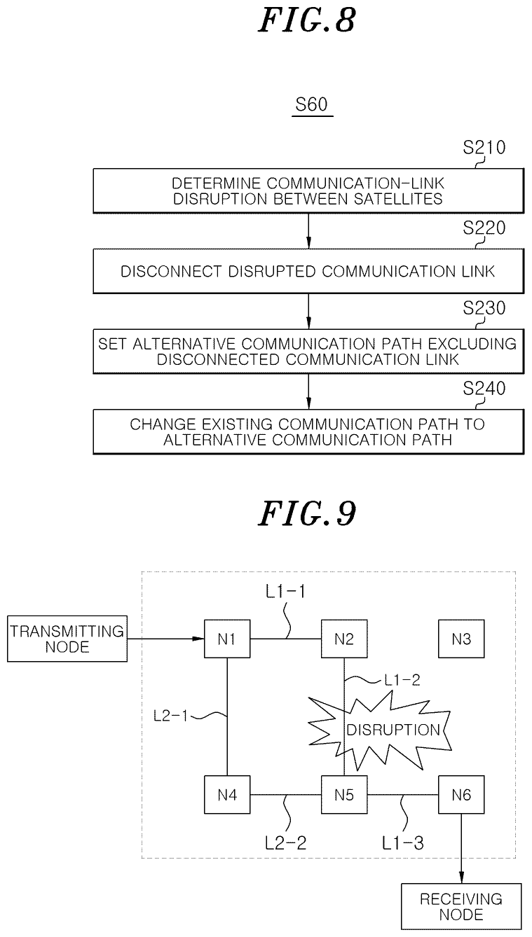

FIG. 8 is a flowchart specifically showing a method of changing a communication path of FIG. 5, and FIG. 9 is a diagram showing an embodiment for a method of changing a communication path of the present disclosure.

First, as shown in FIG. 9, the above-described communication-path estimation part 153 may estimate the communication path including the plurality of communication links.

For example, the communication-path estimation part 153 may estimate communication paths including a 1-1 communication link L1-1 between the first satellite node N1 and the second satellite node N2, a 1-2 communication link L1-2 between the second satellite node N2 and the fifth satellite node N5, a 1-3 communication link L1-3 between the fifth satellite node N5 and the sixth satellite node N6, a 2-1 communication link L2-1 between the first satellite node N1 and the fourth satellite node N4, and a 2-2 communication link L2-2 between the fourth satellite node N4 and the fifth satellite node N5.

Referring to FIG. 8, the communication-path restoration part 155 may determine link disruption in at least one communication link among the plurality of communication links depending on whether a response message is transmitted between the plurality of satellite nodes N1 to N6 included in the estimated communication path, that is, the plurality of low earth orbit satellites (S210).

Here, for the convenience of explanation, an example where the data packet transmitted from the transmitting node to the first satellite node N1, that is, the 1-1 low earth orbit satellite 101-1, is transmitted through the 1-1 communication link L1-1, the 1-2 communication link L1-2, and the 1-3 communication link L1-3 among the estimated communication paths, to the sixth satellite node N6, that is, the 2-3 low earth orbit satellite 102-3 and then received at the receiving node will be described.

As shown in FIG. 9, the second satellite node N2, that is, the 1-2 low earth orbit satellite 101-2, may transmit the data packet through the 1-2 communication link L1-2 to the fifth satellite node N5, that is, the 2-2 low earth orbit satellite 102-2. Thus, the communication-path restoration part 155 of the 1-2 low earth orbit satellite 101-2 may determine whether a response message, that is, a data packet reception complete message is received from the 2-2 low earth orbit satellite 102-2.

At this time, if the 1-2 low earth orbit satellite 101-2 does not receive the response message, the communication-path restoration part 155 may determine that the 1-2 communication link L1-2 is disrupted.

Subsequently, the 1-2 low earth orbit satellite 101-2 may notify the 1-1 low earth orbit satellite 101-1, connected to another communication link, that is, the 1-1 communication link L1-1, of the disruption of the 1-2 communication link L1-2, and simultaneously request the setting of the alternative communication path. At the same time, the communication-path restoration part 155 of the 1-2 low earth orbit satellite 101-2 may disconnect the disrupted 1-2 communication link L1-2 (S220).

Next, the low earth orbit satellites included in the estimated communication path may set the alternative communication path using remaining communication links excluding the disrupted 1-2 communication link L1-2 among the plurality of communication links of the estimated communication link (S230).

As shown in FIG. 9, the 1-1 low earth orbit satellite 101-1 and the 2-1 low earth orbit satellite 102-1 included in the estimated communication path may extract the 2-1 communication link L2-1 and the 2-2 communication link L2-2, respectively, from the plurality of communication links as the alternative communication link. Further, the alternative communication path, that is, the alternative communication path including the 2-1 communication link L2-1, the 2-2 communication link L2-2, and the 1-3 communication link L1-3 may be set using the extracted alternative communication link.

Subsequently, the existing communication path, that is, the estimated communication path, may be changed using the set alternative communication path (S240). Thus, the data packet transmitted from the transmitting node to the 1-1 low earth orbit satellite 101-1 may be transmitted through the changed communication path including the 2-1 communication link L2-1, the 2-2 communication link L2-2, and the 1-3 communication link L1-3 to the 2-3 low earth orbit satellite 102-3 and then received at the receiving node.

As such, the communication-path setting method of this embodiment may estimate the communication path for the plurality of low earth orbit satellites of the clustered low earth orbit satellite network 100 from the topology information for each time zone using the previously learned neural network model, and may set the final communication path according to the determination of the validity of the estimated communication path.

Therefore, the present disclosure can establish a fast and accurate communication path between the plurality of low earth orbit satellites even without searching for a separate communication path. This prevents the loss of the transmitted/received data packet, thus preventing the performance of the clustered low earth orbit satellite network 100 from deteriorating.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for setting a communication path in a clustered low earth orbit satellite network including a plurality of low earth orbit satellites, the method comprising:
generating topology information of each low earth orbit satellite based on orbit information of the clustered low earth orbit satellite network;
estimating a communication path between the plurality of low earth orbit satellites from the topology information using pre-trained communication-path estimation model; and
setting a final communication path of the clustered low earth orbit satellite network by determining validity of the estimated communication path.

2. The method of claim 1, wherein setting the final communication path includes:
setting the estimated communication path as the final communication path, in response to all communication links between the low earth orbit satellites included in the estimated communication path being valid; and
setting an alternative communication path to change the estimated communication path and setting the changed communication path as the final communication path, in response to at least one communication link among the plurality of communication links being invalid.

3. The method of claim 2, wherein setting the final communication path further includes:
changing the estimated communication path to the alternative communication path, in response to the alternative communication path being set within a preset time range; and
waiting for generation of subsequent topology information, in response to the alternative communication path not being set within the preset time range.

4. The method of claim 3, wherein changing the estimated communication path to the alternative communication path includes:
determining a disrupted communication link among the plurality of communication links;
setting the alternative communication path by extracting at least one alternative link from remaining communication links excluding the disrupted communication link; and
changing the estimated communication path using the alternative communication path.

5. The method of claim 1, wherein the validity of the estimated communication path is determined depending on whether there is a response message between the low earth orbit satellites included in the estimated communication path.

6. The method of claim 1, wherein generating the topology information includes:
estimating a location of each low earth orbit satellite on the basis of the orbit information;
mapping a plurality of satellite nodes corresponding to the plurality of low earth orbit satellites, respectively, and a communication link between the plurality of satellite nodes to a virtual topology based on the estimated location of each low earth orbit satellite;
setting a color satellite node and a color and width of the communication link based on a preset color table; and
generating the topology information by adjusting color transparency of the communication link based on network state information for each time zone.

7. The method of claim 6, wherein each satellite node includes a plurality of division areas corresponding to a transmission link and a reception link for a plurality of communication directions of each low earth orbit satellite, and
wherein each division area is set to a different color based on the network state information.

8. The method of claim 1, wherein the pre-trained communication-path estimation model is configured for reinforcement training to output the estimated communication path for the plurality of low earth orbit satellites of the clustered low earth orbit satellite network corresponding to input of the topology information and the network state information.

9. A communication path setting device in a clustered low earth orbit satellite network including a plurality of low earth orbit satellites, the communication path setting device comprising:
a memory configured to store one or more instructions; and
a processor configured to execute the one or more instructions to:
generate topology information of each low earth orbit satellite based on orbit information of the clustered low earth orbit satellite network;
estimate a communication path between the plurality of low earth orbit satellites from the topology information using pre-trained communication-path estimation model; and
set a final communication path of the clustered low earth orbit satellite network by determining validity of the estimated communication path.

10. The communication path setting device of claim 9, wherein the processor is configured to:
set the estimated communication path as the final communication path, in response to all communication links between the low earth orbit satellites included in the estimated communication path being valid; and
set an alternative communication path to change the estimated communication path and set the changed communication path as the final communication path, in response to at least one communication link among the plurality of communication links being invalid.

11. The communication path setting device of claim 10, wherein the processor is configured to:
change the estimated communication path to the alternative communication path, in response to the alternative communication path being set within a preset time range; and
wait for generation of subsequent topology information, in response to the alternative communication path not being set within the preset time range.

12. The communication path setting device of claim 11, wherein the processor is configured to:
determine a disrupted communication link among the plurality of communication links;
set the alternative communication path by extracting at least one alternative link from remaining communication links excluding the disrupted communication link;
and change the estimated communication path using the alternative communication path.

13. The communication path setting device of claim 9, wherein the processor is configured to determine the validity of the estimated communication path depending on whether there is a response message between the low earth orbit satellites included in the estimated communication path.

14. The communication path setting device of claim 11, wherein the processor is configured to:
estimate a location of each low earth orbit satellite on the basis of the orbit information;
map a plurality of satellite nodes corresponding to the plurality of low earth orbit satellites, respectively, and a communication link between the plurality of satellite nodes to a virtual topology based on the estimated location of each low earth orbit satellite;
set a color satellite node and a color and width of the communication link based on a preset color table; and
generate the topology information by adjusting color transparency of the communication link based on network state information for each time zone.

15. The communication path setting device of claim 14, wherein each satellite node includes a plurality of division areas corresponding to a transmission link for a plurality of communication directions of each low earth orbit satellite and a reception link for the plurality of communication directions of each low earth orbit satellite, and
wherein each division area is set to a different color based on the network state information.

16. The communication path setting device of claim 9, wherein the pre-trained communication-path estimation model is configured for reinforcement training to output the estimated communication path for the plurality of low earth orbit satellites of the clustered low earth orbit satellite network corresponding to input of the topology information and the network state information.

17. A non-transitory computer readable storage medium storing computer executable instructions that cause, when executed by one or more processors, the one or more processors to perform the method of claim 1.

18. The non-transitory computer readable storage medium of claim 17, wherein setting the final communication path includes:
setting the estimated communication path as the final communication path, in response to all communication links between the low earth orbit satellites included in the estimated communication path being valid; and
setting an alternative communication path to change the estimated communication path and setting the changed communication path as the final communication path, in response to at least one communication link among the plurality of communication links being invalid.

19. The non-transitory computer readable storage medium of claim 18, wherein the setting the final communication path further includes:
changing the estimated communication path to the alternative communication path, in response to the alternative communication path being set within a preset time range; and
waiting for generation of subsequent topology information, in response to the alternative communication path not being set within the preset time range.

20. The non-transitory computer readable storage medium of claim 19, wherein changing the estimated communication path to the alternative communication path includes:
determining a disrupted communication link among the plurality of communication links;
setting the alternative communication path by extracting at least one alternative link from remaining communication links excluding the disrupted communication link; and
changing the estimated communication path using the alternative communication path.
